(19) United States
(12) Patent Application Publication
(10) Pub. No.: US 2025/0304808 A1
(43) Pub. Date: Oct. 2, 2025

(54) Non-Aqueous Ink Jet Ink Composition And Ink Jet Recording Method

(71) Applicant: SEIKO EPSON CORPORATION, Tokyo (JP)

(72) Inventors: Kenichiro KUBOTA, Matsumoto (JP); Nozomi SATO, Shiojiri (JP)

(21) Appl. No.: 19/089,471

(22) Filed: Mar. 25, 2025

(30) Foreign Application Priority Data
Mar. 26, 2024 (JP) 2024-050333

(51) Int. Cl. C09D 11/36; C09D 11/322

(52) U.S. Cl. CPC C09D 11/36; C09D 11/322

(57) ABSTRACT

A non-aqueous ink jet ink composition of the present disclosure includes a pigment represented by the following Formula (1) and an organic solvent, in which the organic solvent includes a glycol diether represented by the following Formula (2).

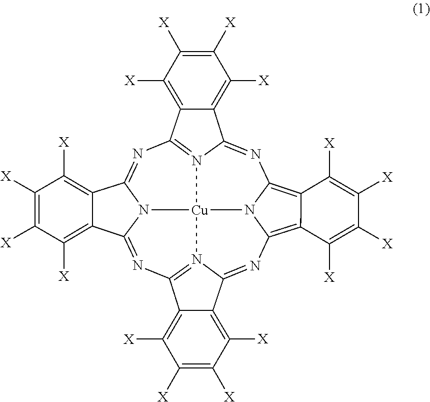

In Formula (1), X's each independently represent a chlorine atom or a bromine atom; and the total number of bromine atoms for X is 6 or more.

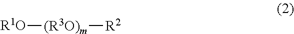

In Formula (2), R¹ and R² each independently represent an alkyl group having 1 or more and 7 or fewer carbon atoms; R³ represents an alkylene group having 1 or more and 3 or fewer carbon atoms; and m represents an integer of 1 or more and 7 or less.

The present application is based on, and claims priority from JP Application Serial Number 2024-050333, filed Mar. 26, 2024, the disclosure of which is hereby incorporated by reference herein in its entirety.

### BACKGROUND

### 1. Technical Field

The present disclosure relates to a non-aqueous ink jet ink composition and an ink jet recording method.

### 2. Related Art

Ink jet recording methods enable recording of high-definition images and are rapidly developed in various fields. Among those, recording methods that use an ink composition containing a pigment are widely used because various color tones can be imparted to various recording media. As such a composition, JP-A-2022-159237 describes a non-aqueous ink composition discharged by an ink jet method, the composition containing a halogenated phthalocyanine pigment, a pigment dispersant, and at least one organic solvent selected from the group consisting of an alkylamide-based solvent, a cyclic amide-based solvent, and a lactone-based solvent.

However, in the related art, the detailed structure of the halogenated phthalocyanine pigment is not clearly known, and although the ink exhibits green color, the green color is not a green color with favorable image quality such as bronze characteristics and chroma.

### SUMMARY

The present disclosure is a non-aqueous ink jet ink composition containing a pigment represented by the following Formula (1) and an organic solvent, in which the organic solvent includes a glycol diether represented by the following Formula (2).

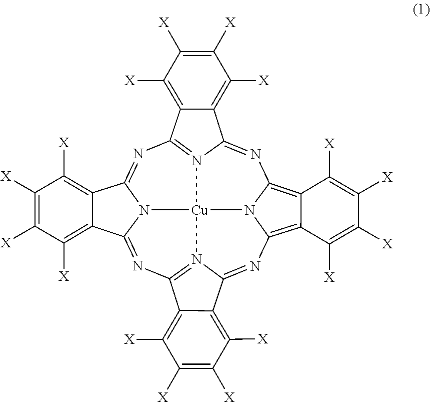

In Formula (1), X's each independently represent a chlorine atom or a bromine atom; and the total number of bromine atoms for X is 6 or more.

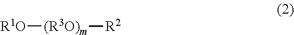

In Formula (2), R¹ and R² each independently represent an alkyl group having 1 or more and 7 or fewer carbon atoms; R³ represents an alkylene group having 1 or more and 3 or fewer carbon atoms; and m represents an integer of 1 or more and 7 or less.

### BRIEF DESCRIPTION OF THE DRAWINGS

FIG. 1 is a flowchart showing an example of an ink jet recording method.

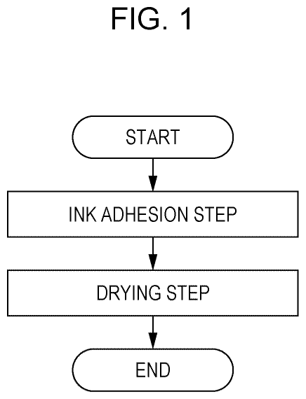

FIG. 2 is a perspective view schematically illustrating the configuration of an ink jet printer.

FIG. 3 is Table 1 showing the composition of a non-aqueous ink jet ink composition.

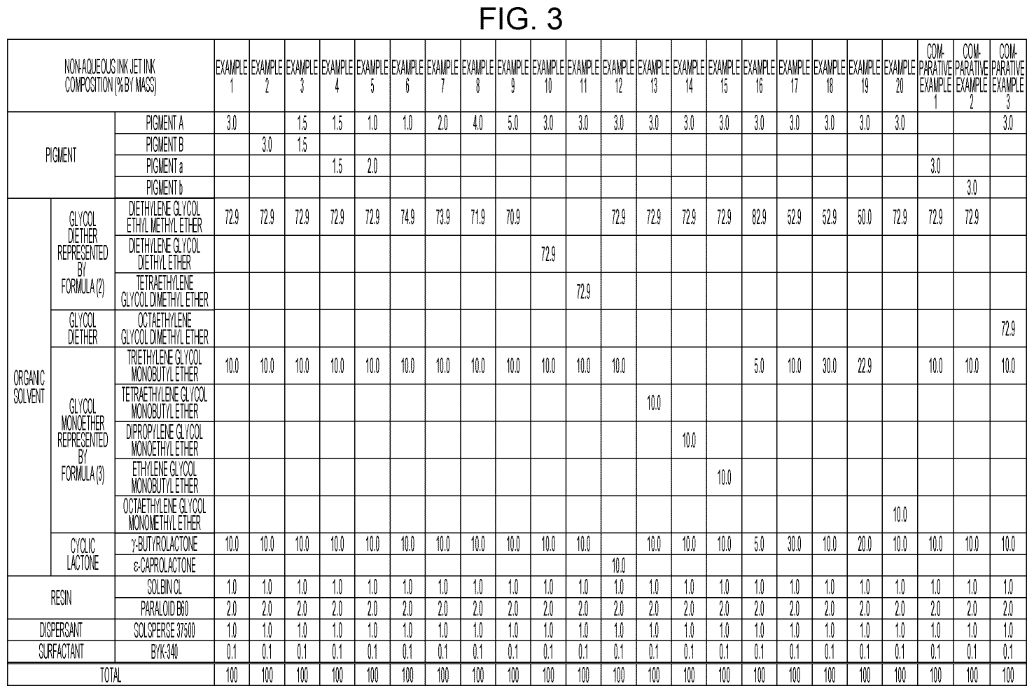

FIG. 4 is Table 2 showing evaluation results.

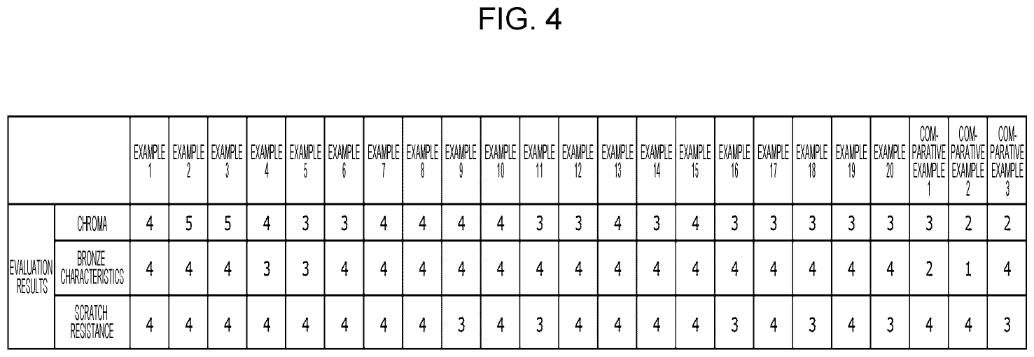

### DESCRIPTION OF EMBODIMENTS

Hereinafter, an embodiment of the present disclosure (hereinafter, referred to as “the present embodiment”) will be described in detail; however, the present disclosure is not limited thereto, and various modifications can be made to the extent that the gist thereof is maintained.

### 1. Non-Aqueous Ink Jet Ink Composition

The non-aqueous ink jet ink composition of the present embodiment (hereinafter, also referred to as “ink composition”) is an ink composition containing a pigment represented by the following Formula (1) and an organic solvent, in which the organic solvent contains a glycol diether represented by the following Formula (2).

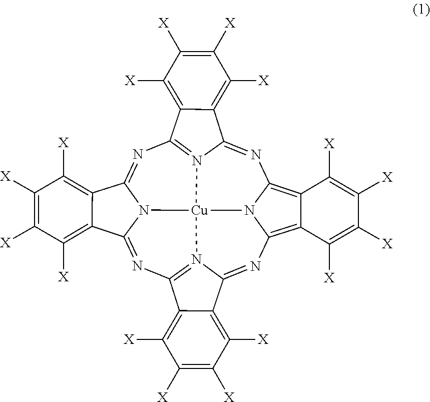

In Formula (1), X's each independently represent a chlorine atom or a bromine atom; and the total number of bromine atoms for X is 6 or more.

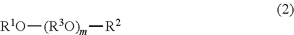

In Formula (2), R¹ and R² each independently represent an alkyl group having 1 or more and 7 or fewer carbon atoms; R³ represents an alkylene group having 1 or more and 3 or fewer carbon atoms; and m represents an integer of 1 or more and 7 or less.

According to the present embodiment, an ink composition which exhibits a green color with favorable image quality such as bronze characteristics and chroma and has favorable scratch resistance and discharge stability, can be obtained.

The reason why excellent effects are obtained by the present embodiment in this way is not clearly understood; however, the inventors of the present disclosure presume the reason as follows.

In the related art, in non-aqueous inks containing a halogenated phthalocyanine pigment, bronzing is likely to occur, and the ink exhibits green color; however, the image quality such as bronze characteristics and chroma is poor. In addition, in the ink composition, it is difficult to obtain favorable scratch resistance and discharge stability. The structure of halogenated phthalocyanine pigments of the related art is not clear; however, when such related art is taken into account, it is presumed that since the planarity of the molecular structure is high, association of the molecules is likely to occur.

Here, generally, the associates of molecules having a planar structure selectively reflect light of specific wavelengths, and therefore, a bronze phenomenon is likely to occur. Furthermore, when associates are aggregated, the ink composition tends to cause ink discharge failure and have poor scratch resistance due to the aggregates.

On the other hand, the pigment represented by Formula (1) according to the present embodiment contains chlorine atoms and bromine atoms in Formula (1), and the total number of bromine atoms is 6 or more. Therefore, in the pigment represented by Formula (1), the planarity of the molecular skeleton is lost due to the steric hindrance of bromine atoms, and distortion occurs. Due to the distortion, association between the pigment molecules is difficult to occur, and aggregation is suppressed.

In addition, the ink composition of the present embodiment contains a glycol diether represented by Formula (2) as an organic solvent. The glycol diether represented by Formula (2) has relatively favorable dryness. In addition, the pigment represented by Formula (1) is satisfactorily dissolved in the organic solvent, and aggregation of the pigment is further suppressed. Therefore, when the ink composition contains a glycol diether represented by Formula (2), more excellent color developability and scratch resistance are obtained.

From the above, it is presumed that the ink composition of the present embodiment can provide an ink composition that exhibits a green color with favorable image quality such as bronze characteristics and chroma, and has favorable scratch resistance and discharge stability. However, the reason is not limited to this.

In the present embodiment, the term “non-aqueous” means that an organic solvent or the like is used as a main solvent, and water is not a main solvent. Here, the term “main solvent” implies that the content in the composition is usually 50% by mass or more, preferably 70% by mass or more, and more preferably 90% by mass or more, with respect to 100% by mass of the composition. Furthermore, when the composition contains water, it is preferable not to intentionally add water as a solvent component in the preparation of the composition. In the preparation of the composition, water may be inevitably included as an impurity. The content of water in the composition is preferably 3.0% by mass or less, more preferably 2.0% by mass or less, even more preferably 1.0% by mass or less, and still more preferably 0.5% by mass or less, with respect to 100% by mass of the composition. The lower limit of the content of water is not particularly limited, and may be equal to or less than the detection limit or may be 0.01% by mass.

Examples of a method for adjusting the content of water in the composition include a method of removing water from each component contained in the composition. Specifically, examples thereof include a method of removing water that is mixed in an organic solvent, a method of removing water from a composition, and a method of suppressing mixing of water during the preparation of a composition. Among them, as a method for removing water that is mixed in an organic solvent, more specific examples include a method of subjecting the organic solvent to distillation and purification, a method of allowing the organic solvent to penetrate through a semi-permeable membrane that is selectively permeable to water, and a method of selectively adsorbing water that is mixed in the organic solvent onto a water adsorbent that adsorbs water. From the viewpoint that the amount of water can be reduced more efficiently and reliably, among those, a method of performing distillation and purification is preferred.

The non-aqueous ink jet ink composition of the present embodiment contains at least a pigment represented by the following Formula (1) and a glycol diether represented by the following Formula (2) as an organic solvent. Compositions containing a solvent are broadly classified into two types, namely, real solvent (high organic solvent) compositions and eco-solvent (low organic solvent) compositions. An eco-solvent composition is a less odorous composition that is considerate of the human body and the environment, and uses an organic solvent that does not fall under the organic solvents specified in the Industrial Safety and Health Act, that does not fall under the first and second classes of organic solvents specified in the Organic Solvent Poisoning Prevention Rules, or the organic solvents that are exempt from the requirement of local exhaust ventilation systems in indoor workplaces in the installation environment defined in the Fire Service Act. The solvent-based composition of the present embodiment can use any of the organic solvents that may be used in the real solvent compositions and the organic solvents that may be used in the eco-solvent compositions; however, it is preferable that the solvent-based composition contains an organic solvent that may be used in the eco-solvent compositions.

Next, each component included in the ink composition will be described.

### 1.1. Pigment Represented by Formula (1)

The ink composition of the present embodiment includes a pigment represented by the following Formula (1). Regarding the pigment represented by Formula (1), one kind thereof may be used alone, or two or more kinds thereof may be used in combination.

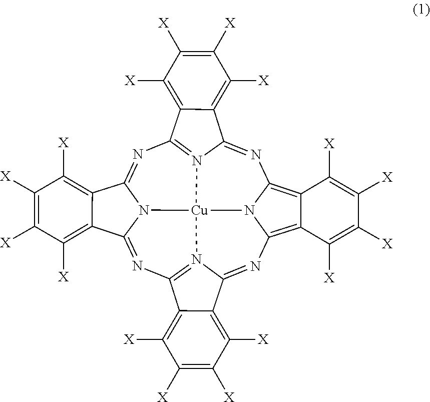

In Formula (1), X's each independently represent a chlorine atom or a bromine atom, and the total number of bromine atoms for X is 6 or more. The total number of bromine atoms for X is preferably 12 or less. The total number of X is 18, which is the total number of chlorine atoms and bromine atoms.

In Formula (1), the total number of bromine atoms for X is preferably 8 or more, more preferably 10 or more, and even more preferably 12. When the total number of bromine atoms for X is in the above-described range, there is a tendency that an ink composition having more favorable scratch resistance and discharge stability and having a green color with more favorable image quality such as bronze characteristics and chroma is obtained.

The ink composition preferably contains a pigment represented by the following Formula (4) as the pigment represented by Formula (1), and more preferably contains a pigment represented by the following Formula (5). When the ink composition contains the above-described pigment, there is a tendency that an ink composition that exhibits a green color with more favorable image quality such as bronze characteristics and chroma, and has more favorable scratch resistance and discharge stability is obtained.

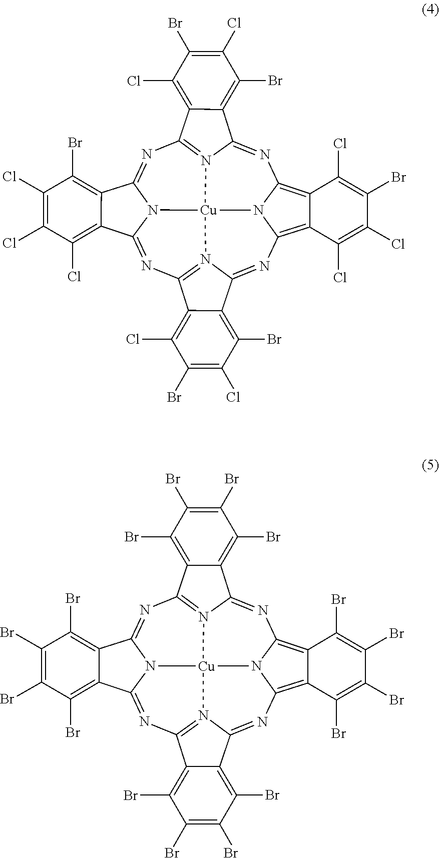

The content of the pigment represented by Formula (1) is preferably 0.5 parts by mass or more and 10.0 parts by mass or less, more preferably 0.7 parts by mass or more and 8.0 parts by mass or less, even more preferably 1.0 parts by mass or more and 5.0 parts by mass or less, and still more preferably 1.5 parts by mass or more and 4.5 parts by mass or less, with respect to 100 parts by mass of the total amount of the ink composition. When the content of the pigment is in the above-described range, there is a tendency that an ink composition exhibits a green color with more favorable image quality such as bronze characteristics and chroma and has more favorable scratch resistance and discharge stability is obtained.

### Method for Preparing Pigment Represented by Formula (1)

In the present embodiment, the pigment represented by Formula (1) can be prepared by suspending copper phthalocyanine in a molten-mixed solvent of anhydrous aluminum chloride and sodium chloride, and blowing chlorine gas and/or bromine gas into the suspension at 160° C. for 20 hours. Here, by adjusting the mixing proportions of chlorine gas and bromine gas, the number of chlorine atoms and bromine atoms substituted in the pigment can be adjusted.

The structure of the pigment represented by Formula (1) can be checked by, for example, using a nuclear magnetic resonance apparatus (NMR), a Fourier transform infrared spectrophotometer (FT-IR), a gas chromatograph-mass spectrometer (GC-MS), and a liquid chromatograph-mass spectrometer (LC-MS).

### 1.2. Other Pigments

The ink composition of the present embodiment may contain another pigment other than the pigment represented by Formula (1) as the pigment. Regarding the other pigment, one kind thereof may be used alone, or two or more kinds thereof may be used in combination.

Examples of such other pigment include a pigment represented by the following Formula (6).

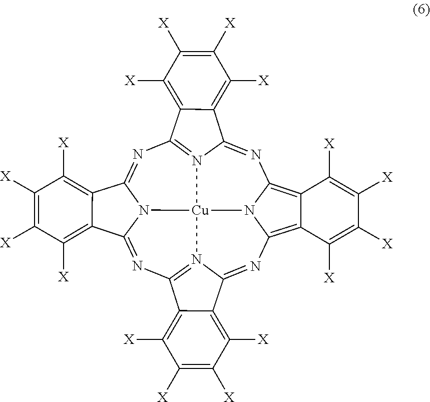

In Formula (6), X's each independently represent a chlorine atom or a bromine atom, and the total number of bromine atoms for X is 5 or less. The total number of bromine atoms for X may be 0 or more, and X may be all chlorine atoms. The total number of X is 18, which is the total number of chlorine atoms and bromine atoms.

It is presumed that the pigment represented by Formula (6) has relatively high planarity of the molecular structure, and association between the molecules is likely to occur. However, even when the ink composition contains such a pigment, as the ink composition contains the pigment represented by Formula (1) and the glycol diether represented by Formula (2), aggregation of the pigment represented by Formula (6) is suitably suppressed. Therefore, the ink composition tends to exhibit a green color with favorable image quality such as bronze characteristics and chroma, and have favorable scratch resistance and discharge stability.

Examples of the pigment represented by Formula (6) include a pigment represented by the following Formula (7) and a pigment represented by the following Formula (8).

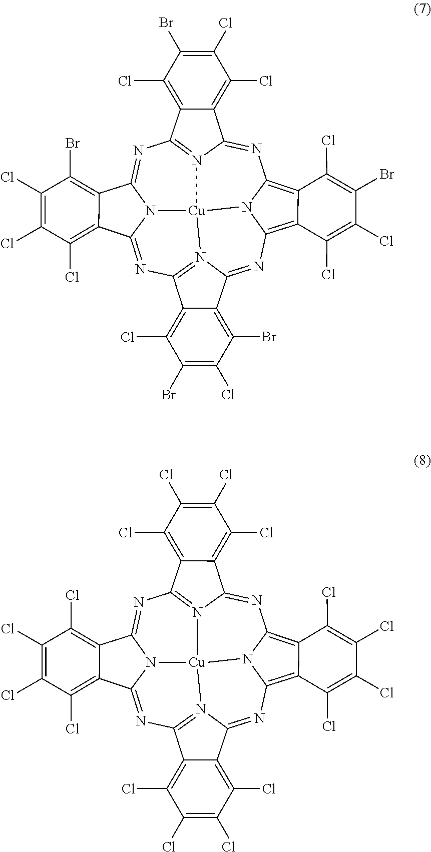

The content of the pigment represented by Formula (6) is preferably 10.0 parts by mass or less, more preferably 6.0 parts by mass or less, even more preferably 4.0 parts by mass or less, and still more preferably 2.5 parts by mass or less, with respect to 100 parts by mass of the total amount of the ink composition. The lower limit of the content of the pigment represented by Formula (6) is usually 0 parts by mass or more, and may be 0.1 parts by mass or more.

### 1.3. Glycol Diether Represented by Formula (2)

The ink composition of the present embodiment contains a glycol diether represented by the following Formula (2) as an organic solvent.

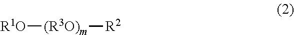

In Formula (2), R¹ and R² each independently represent an alkyl group having 1 or more and 7 or fewer carbon atoms, R³ represents an alkylene group having 1 or more and 3 or fewer carbon atoms, and m represents an integer of 1 or more and 7 or less.

Regarding the glycol diether represented by Formula (2), one kind thereof may be used alone, or two or more kinds thereof may be used in combination.

In Formula (2), R¹ and R² each independently represent preferably an alkyl group having 1 or more and 5 or fewer carbon atoms, and more preferably an alkyl group having 1 or more and 4 or fewer carbon atoms. R³ preferably represents an alkylene group having 2 or more and 3 or fewer carbon atoms. m preferably represents an integer of 1 or more and 6 or less, more preferably 1 or more and 4 or less, and even more preferably 1 or more and 3 or less. When R¹, R², R³, and m in Formula (2) have a configuration such as described above, an ink composition that exhibits a green color with more favorable image quality such as bronze characteristics and chroma and has more favorable scratch resistance and discharge stability, tends to be obtained.

Examples of the glycol diether represented by Formula (2) include ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Among those, it is preferable that the glycol diether represented by Formula (2) includes one or more selected from the group consisting of diethylene glycol ethyl methyl ether, diethylene glycol diethyl ether, and tetraethylene glycol dimethyl ether, and more preferably one or more selected from the group consisting of diethylene glycol ethyl methyl ether and diethylene glycol diethyl ether. When the glycol diether represented by Formula (2) is the above-described glycol diether, an ink composition that exhibits a green color with more favorable image quality such as bronze characteristics and chroma and has more favorable scratch resistance and discharge stability, tends to be obtained.

The content of the glycol diether represented by Formula (2) is preferably 5.0 parts by mass or more and 90.0 parts by mass or less, more preferably 20.0 parts by mass or more and 80.0 parts by mass or less, even more preferably 30.0 parts by mass or more and 70.0 parts by mass or less, and still more preferably 45.0 parts by mass or more and 75.0 parts by mass or less, with respect to 100 parts by mass of the total amount of the ink composition. When the content of the glycol diether represented by Formula (2) is within the above-described range, an ink composition that exhibits a green color with more favorable image quality such as bronze characteristics and chroma and has more favorable scratch resistance and discharge stability, tends to be obtained.

The mass ratio (glycol diether/pigment) of the glycol diether represented by Formula (2) with respect to the pigment represented by Formula (1) is preferably 10 or more and 80 or less. When the mass ratio is within the above-described range, an ink composition that exhibits a green color with more favorable image quality such as bronze characteristics and chroma and has more favorable scratch resistance and discharge stability, tends to be obtained.

### 1.4. Glycol Monoether Represented by Formula (3)

It is preferable that the ink composition of the present embodiment further contains a glycol monoether represented by the following Formula (3) as an organic solvent.

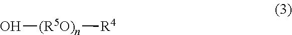

In Formula (3), R⁴ represents an alkyl group having 1 or more and 7 or fewer carbon atoms, R⁵ represents an alkylene group having 1 or more and 3 or fewer carbon atoms, and n represents an integer of 1 or more and 8 or less.

When the ink composition contains the glycol monoether represented by Formula (3), since the drying property is appropriately decreased, and the aggregability of the pigment is further suppressed, the ink composition tends to obtain more excellent color developability and scratch resistance. Regarding the glycol monoether represented by Formula (3), one kind thereof may be used alone, or two or more kinds thereof may be used in combination.

In Formula (3), R⁴ preferably represents an alkyl group having 1 or more and 5 or fewer carbon atoms, and more preferably represents an alkyl group having 1 or more and 4 or fewer carbon atoms. R⁵ preferably represents an alkylene group having 2 or more and 3 or fewer carbon atoms, and more preferably represents an alkylene group having 2 carbon atoms, that is, an ethylene group. n preferably represents an integer of 1 or more and 6 or less, and more preferably represents an integer of 1 or more and 4 or less. When R⁴, R⁵, and n in Formula (3) have the above-described configuration, an ink composition that exhibits a green color with more favorable image quality such as bronze characteristics and chroma and has more favorable scratch resistance and discharge stability, tends to be obtained.

Examples of the glycol monoether represented by Formula (3) include ethylene glycol monomethyl ether, ethylene glycol monoethyl ether, ethylene glycol mono-n-propyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, octaethylene glycol monomethyl ether, propylene glycol monomethyl ether, propylene glycol monoethyl ether, dipropylene glycol monomethyl ether, and dipropylene glycol monoethyl ether.

Among them, it is preferable that the glycol monoether represented by Formula (3) includes one or more selected from the group consisting of triethylene glycol monobutyl ether, tetraethylene glycol monobutyl ether, dipropylene glycol monomethyl ether, ethylene glycol monobutyl ether, and octaethylene glycol monomethyl ether, and more preferably one or more selected from the group consisting of triethylene glycol monobutyl ether, tetraethylene glycol monobutyl ether, and ethylene glycol monobutyl ether. When the glycol monoether represented by Formula (3) is the above-described glycol monoether, an ink composition that exhibits a green color with more favorable image quality such as bronze characteristics and chroma and has more favorable scratch resistance and discharge stability, tends to be obtained.

The content of the glycol monoether represented by Formula (3) is preferably 5.0 parts by mass or more and 80.0 parts by mass or less, more preferably 7.0 parts by mass or more and 60.0 parts by mass or less, even more preferably 10.0 parts by mass or more and 40.0 parts by mass or less, and still more preferably 15.0 parts by mass or more and 20.0 parts by mass or less, with respect to 100 parts by mass of the total amount of the ink composition. When the content of the glycol monoether represented by Formula (3) is within the above-described range, an ink composition that exhibits a green color with more favorable image quality such as bronze characteristics and chroma and has more favorable scratch resistance and discharge stability, tends to be obtained.

### 1.5. Cyclic Lactone

It is preferable that the ink composition of the present embodiment further contains a cyclic lactone as the organic solvent. When the ink composition contains a cyclic lactone, the permeability of the ink to the recording medium is further improved, and therefore, the ink composition tends to obtain more excellent scratch resistance. Since more excellent scratch resistance tends to be obtained, the recording medium preferably contains a vinyl chloride-based resin. Regarding the cyclic lactone, one kind thereof may be used alone, or two or more kinds thereof may be used in combination.

The cyclic lactone is not particularly limited as long as it is a compound having a cyclic structure formed by an ester bond. Examples of such a cyclic lactone include γ-lactone having a 5-membered ring structure, 5-lactone having a 6-membered ring structure, and ε-lactone having a 7-membered ring structure.

More specifically, examples of the cyclic lactone include γ-butyrolactone, γ-valerolactone, γ-hexalactone, γ-heptalactone, γ-octalactone, γ-nonalactone, γ-decalactone, γ-undecalactone, δ-valerolactone, δ-hexalactone, δ-heptalactone, δ-octalactone, δ-nonalactone, δ-decalactone, δ-undecalactone, and ε-caprolactone.

Among them, it is preferable that the cyclic lactone includes one or more selected from the group consisting of a γ-lactone having a 5-membered ring structure and an ε-lactone having a 7-membered ring structure, more preferably one or more selected from the group consisting of γ-butyrolactone and ε-caprolactone, and even more preferably γ-butyrolactone. When the cyclic lactone is the above-described lactone, an ink composition that exhibits a green color with more favorable image quality such as bronze characteristics and chroma and has more favorable scratch resistance and discharge stability, tends to be obtained.

The content of the cyclic lactone is preferably 1.0 part by mass or more and 50.0 parts by mass or less, more preferably 3.0 parts by mass or more and 40.0 parts by mass or less, even more preferably 5.0 parts by mass or more and 30.0 parts by mass or less, and still more preferably 7.0 parts by mass or more and 15.0 parts by mass or less, with respect to 100 parts by mass of the total amount of the ink composition. When the content of the cyclic lactone is within the above-described range, an ink composition that has more favorable scratch resistance and discharge stability and exhibits a green color with more favorable image quality such as bronze characteristics and chroma, tends to be obtained.

### 1.6. Other Organic Solvent

The ink composition of the present embodiment may further contain, as an organic solvent, a glycol diether represented by Formula (2), a glycol monoether represented by Formula (3), and another organic solvent other than a cyclic lactone. Regarding the other organic solvent, one kind thereof may be used alone, or two or more kinds thereof may be used in combination.

Examples of such other organic solvent include alcohols; hydrocarbon-based compounds; ketones; esters other than cyclic lactones; and polar compounds such as propylene carbonate, N-methyl-2-pyrrolidone, N,N-dimethylformamide, N,N-dimethylacetamide, dimethyl sulfoxide, cyclohexanone, and acetonitrile.

Examples of the alcohols include monohydric alcohols such as methanol, ethanol, propanol, isopropanol and butanol; and polyhydric alcohols such as ethylene glycol, propylene glycol, and 1,2-hexanediol.

Examples of the hydrocarbon-based compounds include n-heptane, n-octane, decane, dodecane, tetradecane, toluene, xylene, cymene, durene, indene, dipentene, tetrahydronaphthalene, decahydronaphthalene, and cyclohexylbenzene.

Examples of the ketone include acetone, methyl ethyl ketone, isophorone, and diethyl ketone.

Examples of the esters other than cyclic lactones include ethyl acetate, propyl acetate, butyl acetate, methyl levulinate, ethyl levulinate, isoamyl isovalerate, isoamyl butyrate, isoamyl acetate, butyl 2-methylvalerate, allyl heptanoate, and ethyl 2-methylvalerate.

The content of the other organic solvent is preferably 0.5 parts by mass or more and 20.0 parts by mass or less with respect to 100 parts by mass of the total amount of the ink composition. When the content of the other organic solvent is within the above-described range, an ink composition that exhibits a green color with more favorable image quality such as bronze characteristics and chroma and has more favorable scratch resistance and discharge stability, tends to be obtained.

### 1.7. Resin

The ink composition of the present embodiment may further contain a resin, mainly for the purpose of adjusting the viscosity of the composition. Regarding the resin, one kind thereof may be used alone, or two or more kinds thereof may be used in combination.

Examples of such a resin include an acrylic resin, a styrene-acrylic resin, a rosin-modified resin, a phenol resin, a terpene-based resin, a polyester resin, a polyamide resin, an epoxy resin, a vinyl chloride resin such as a vinyl chloride-vinyl acetate copolymer resin, a fiber-based resin such as cellulose acetate butyrate, and a vinyl toluene-α-methylstyrene copolymer resin. Among those, the resin is preferably a vinyl chloride resin, and more preferably a vinyl chloride-vinyl acetate copolymer resin. When the ink composition contains such a resin, the scratch resistance of the obtained recorded matter tends to be further improved.

Examples of the vinyl chloride resin include copolymer resins of vinyl chloride and one or more selected from the group consisting of vinyl acetate, vinylidene chloride, acryl, maleic acid, and vinyl alcohol. Among those, a vinyl chloride-vinyl acetate copolymer resin, which is a copolymer of vinyl chloride and vinyl acetate, is preferred, and a vinyl chloride-vinyl acetate copolymer resin having a glass transition temperature of 60° C. or higher and 80° C. or lower is more preferred. The above-described acryl is not particularly limited as long as it is a compound having an acrylic group or methacrylic group that can be copolymerized with vinyl chloride, and examples thereof include acrylic acid esters such as methyl acrylate, ethyl acrylate, isopropyl acrylate, n-butyl acrylate, and 2-ethylhexyl acrylate; methacrylic acid esters such as methyl methacrylate, ethyl methacrylate, isopropyl methacrylate, n-butyl methacrylate, isobutyl methacrylate, t-butyl methacrylate, cyclohexyl methacrylate, and 2-ethylhexyl methacrylate; carboxyl group-containing monomers such as acrylic acid, methacrylic acid, maleic acid, fumaric acid, itaconic acid, mono-n-butyl maleate, mono-n-butyl fumarate, and mono-n-butyl itaconate; hydroxyl group-containing (meth)acrylic acid esters, amide group-containing monomers, glycidyl group-containing monomers, cyano group-containing monomers, hydroxyl group-containing allyl compounds, tertiary amino group-containing monomers, and alkoxy silane group-containing monomers. Those acryls can be used singly or in combination of two or more kinds thereof.

The content of the resin is preferably 0.1% by mass or more and 10% by mass or less, more preferably 0.3% by mass or more and 5.0% by mass or less, and even more preferably 0.5% by mass or more and 3.0% by mass or less, with respect to the total amount of the ink composition. When the content of the resin is within the above-described range, the ink composition tends to have more excellent scratch resistance.

### 1.8. Other Components

The ink composition may further contain, in addition to the above-described components, various additives that can be usually used in the ink composition, such as a color material such as a dye, a penetrating agent, a surface treatment agent, a leveling agent, a polymerization accelerator, a polymerization inhibitor, a photopolymerization initiator, a dispersant, a surfactant, a permeation promoter, a moisturizer, a coloring agent, a fixing agent, an antifungal agent, a preservative, an antioxidant, a chelating agent, a thickening agent, a pH adjusting agent, and a sensitizer. Regarding the additives, one kind thereof may be used alone, or two or more kinds thereof may be used in combination.

Examples of the surfactant include an acetylene glycol-based surfactant, a silicone-based surfactant, and a fluorine-based surfactant.

The content of the additives is preferably 0.01% by mass or more and 10.0% by mass or less in total with respect to the total amount of the ink composition.

### 1.9. Method for Producing Ink Composition

The ink composition can be prepared by mixing a pigment represented by Formula (1), a glycol diether represented by Formula (2), as well as optionally a glycol monoether represented by Formula (3), a cyclic lactone, another organic solvent, a resin, and other components in any order, and performing filtration or the like as necessary to remove impurities, foreign matter, and the like. As a method of mixing each of the components, a method of sequentially introducing each component into a container equipped with a stirring device such as a mechanical stirrer or a magnetic stirrer, and stirring and mixing the mixture, is used. Examples of the filtration method include centrifugal filtration and filter filtration.

### 2. Ink Jet Recording Method

### 2.1. Ink Jet Recording Method

The ink jet recording method of the present embodiment includes a step of discharging the ink composition of the present embodiment from an ink jet head by an ink jet method and adhering the ink composition to a recording medium. Specifically, droplets of the ink composition are discharged, and the droplets are adhered to a recording medium, preferably a low-absorbent recording medium, to record an image.

In the present specification, the term “low-absorbent recording medium” refers to a recording medium in which the amount of water absorption from the start of contact to 30 msec^{1/2} in the Bristow method is 10 mL/m² or less, and it is desirable that at least the recording surface has this property. According to this definition, the “low-absorbent recording medium” in the present specification also includes a non-absorbent recording medium that does not absorb water at all. The Bristow method is the most popular method for measuring the amount of liquid absorption in a short time and is also adopted by Japan Technical Association of the Pulp and Paper Industry (JAPAN TAPPI). The details of the test method are laid out in the standard No. 51 “JAPAN TAPPI Paper Pulp Test Method 2000 Edition” under “Paper and paperboard-Liquid absorbency test method-Bristow method”.

Specifically, examples of the low-absorbent recording medium include a sheet, a film, and a fiber product, all of which contain a low-absorbent material. Furthermore, the low-absorbent recording medium may be, for example, a medium including a layer containing a low-absorbent material (hereinafter, also simply referred to as a “low-absorbent layer”) on the surface of a base material of paper, fiber, leather, plastic, glass, ceramic, or metal. Examples of the low-absorbent material include an olefin-based resin, an ester-based resin, a urethane-based resin, an acrylic resin, and a vinyl chloride-based resin.

Among those, the recording medium preferably contains a vinyl chloride-based resin. That is, as the low-absorbent recording medium, a medium having a recording surface containing a vinyl chloride-based resin can be preferably used. Specific examples of vinyl chloride-based resins include, for example, polyvinyl chloride, a vinyl chloride-ethylene copolymer, a vinyl chloride-vinyl acetate copolymer, a vinyl chloride-vinyl ether copolymer, a vinyl chloride-vinylidene chloride copolymer, a vinyl chloride-maleic acid ester copolymer, a vinyl chloride-(meth)acrylic acid copolymer, a vinyl chloride-(meth)acrylic acid ester copolymer, and a vinyl chloride-urethane copolymer. The various characteristics such as the thickness, shape, color, softening temperature, and hardness of the low-absorbent recording medium are not particularly limited.

As the ink composition has the above-described composition, the ink composition can exhibit a green color with more favorable image quality such as bronze characteristics and chroma and exhibit an effect of having excellent scratch resistance particularly on a low-absorbent recording medium, especially a recording medium containing a vinyl chloride-based resin. Therefore, according to the ink jet recording method according to the present embodiment, by adhering the droplets of the above-described non-aqueous composition particularly to a low-absorbent recording medium, especially a recording medium containing a vinyl chloride-based resin, an image that exhibits a green color with more favorable image quality such as bronze characteristics and chroma and has more excellent scratch resistance can be recorded.

The ink jet recording apparatus used in the ink jet recording method is not particularly limited; however, a drop-on-demand type ink jet recording apparatus is preferred. Examples of the drop-on-demand type ink jet recording apparatus include an apparatus that adopts a piezoelectric element recording method of performing recording by using a piezoelectric element disposed in a recording head, and an apparatus that adopts a thermal jet recording method of performing recording by using thermal energy emitted from a heater or the like of a heat-generating resistance element disposed in a recording head; however, any recording method can be adopted. Hereinafter, an example of the ink jet recording apparatus of the present embodiment will be described in more detail.

### 2.2. Ink Jet Recording Apparatus

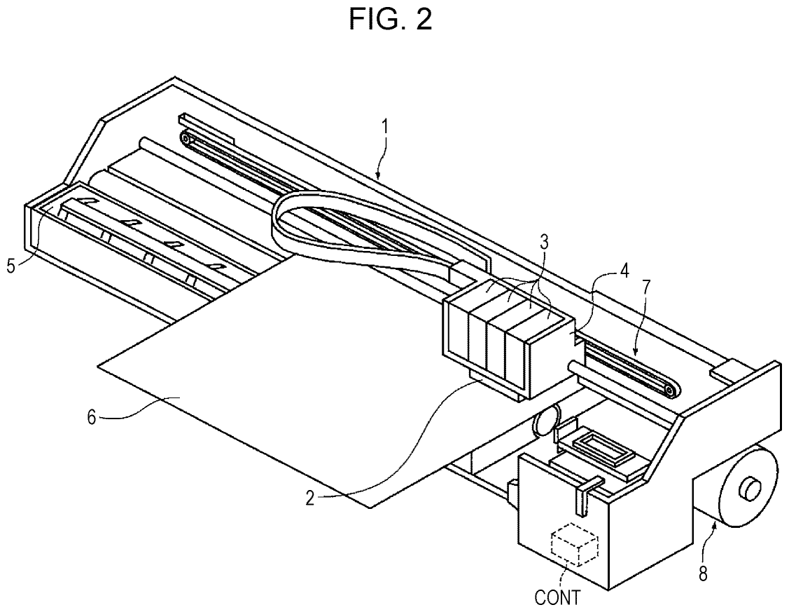

As the ink jet recording apparatus of the present embodiment, a commonly known ink jet printer can be used. Examples of the ink jet printer include the ink jet printer shown in FIG. 2 (hereinafter, also simply referred to as a “printer”).

FIG. 2 is a perspective view illustrating a configuration of a printer 1 according to the present embodiment. As illustrated in FIG. 2, the printer 1 includes: a carriage 4 on which an ink jet recording head 2 is mounted and on which an ink cartridge 3 is attachably and detachably mounted; a platen 5 disposed below the ink jet recording head (ink jet head) 2 and on which a recording medium 6 is transported; a carriage moving mechanism 7 that moves the carriage 4 in a medium width direction (main scanning direction S) of the recording medium 6; and a medium feeding mechanism 8 that transports the recording medium 6 in a medium feeding direction. In addition, the printer 1 includes a control section CONT that controls the overall operation of the printer 1.

The recording head 2 has a cavity for discharging the accommodated ink composition through a nozzle, a discharge drive section provided for each cavity for applying a discharge driving force to the ink composition, and a nozzle provided in each cavity for discharging the ink composition to the outside of the head. A plurality of cavities, and a plurality of discharge drive sections and nozzles provided for each cavity may be each independently provided in one head. The discharge drive section can be formed by using an electromechanical conversion element such as a piezoelectric element that changes the volume of the cavity by mechanical deformation, an electronic thermal conversion element that generates air bubbles in the ink composition by generating heat and discharges the ink composition, or the like. The printer 1 may be provided with one or a plurality of heads for one type of ink composition.

The ink cartridge 3 includes a plurality of independent cartridges, and each cartridge is filled with the above-described ink composition. The cartridge filled with the ink composition does not need to be mounted on the carriage 4 during normal printing, and may be mounted on the carriage 4 at least when washing the flow path of the ink composition.

The platen 5 includes a platen heater and is configured to heat the recording medium to a set temperature. The recording head 2 does not include a built-in heater. However, as a result of heating of the recording medium, the temperature of the recording head rises, and the temperature of the non-aqueous composition accommodated in the recording head 2 also tends to rise. Although not shown in the drawings, the printer 1 may include an after-heater in the recording medium transport path downstream of the platen heater.

The ink composition is discharged from the recording head 2. Here, the temperature of the platen when the ink composition is discharged from the recording head 2 is preferably 35° C. or higher, and more preferably 40° C. or higher. Furthermore, the temperature of the platen when the ink composition is discharged from the recording head 2 is preferably 80° C. or lower, more preferably 70° C. or lower, even more preferably 60° C. or lower, and still more preferably 50° C. or lower. It is preferable to set the temperature of the platen to be within the above-described range by the platen heater, from the viewpoint that the quality of the recorded matter can be further improved.

Furthermore, in the present embodiment, the discharge frequency when the ink composition is discharged from the recording head 2 is preferably 1.0 kHz or more and 200 kHz or less. When the discharge frequency is equal to or less than the above-described range, it is preferable from the viewpoint of having more excellent discharge stability, and when the discharge frequency is equal to or more than the above-described range, it is preferable from the viewpoint that the recording speed is faster. The discharge frequency means the frequency of discharge of one droplet of the ink composition as the discharge unit. From the viewpoint of further increasing the recording speed, the discharge frequency is preferably 2.0 kHz or more, more preferably 3.0 kHz or more, even more preferably 5.0 kHz or more, and still more preferably 10 kHz or more. Furthermore, from the viewpoint of further increasing the discharge stability, the discharge frequency is preferably 200 kHz or less, more preferably 150 kHz or less, even more preferably 100 kHz or less, and still more preferably 50 kHz or less. In addition, from the viewpoint of having more excellent discharge stability while ensuring the recording speed, the discharge frequency is preferably 20 kHz or less, and more preferably 15 kHz or less. On the other hand, in terms of having more excellent recording speed while ensuring the discharge stability, the discharge frequency is preferably 15 kHz or more, and more preferably 20 kHz or more.

As the printer 1 of the present embodiment, a so-called on-carriage type printer in which the ink cartridge 3 is mounted on the carriage 4 was mentioned as an example; however, the present disclosure is not limited thereto. For example, the printer 1 may be a so-called off-carriage type printer in which, for example, an ink pack and an ink container of an ink cartridge filled with the ink composition are mounted on the housing or the like of the printer, and the ink composition is supplied to the head 2 via an ink supply tube.

In the ink jet recording apparatus of the present embodiment, an ink set having a plurality of ink compositions can be used. Such an ink set may have a plurality of the ink compositions of the present embodiment, and may further have other non-aqueous compositions different from the ink compositions of the present embodiment. Furthermore, in that case, the ink set may be an ink set in which the ink composition of the present embodiment is used as a green ink, and other non-aqueous compositions are used as a magenta ink, a yellow ink, and a cyan ink.

### EXAMPLES

Hereinafter, the present disclosure will be described in detail with reference to Examples; however, the present disclosure is not limited thereto. Hereinafter, unless particularly stated otherwise, the unit “parts” refers to “parts by mass”.

### 1. Pigments (a), (B), (a), and (b)

Pigments (A), (B), (a), and (b) can be each prepared by the above-described method. In the pigment (A) having a structure represented by the following Formula (4), the total number of chlorine atoms is 10, and the total number of bromine atoms is 6.

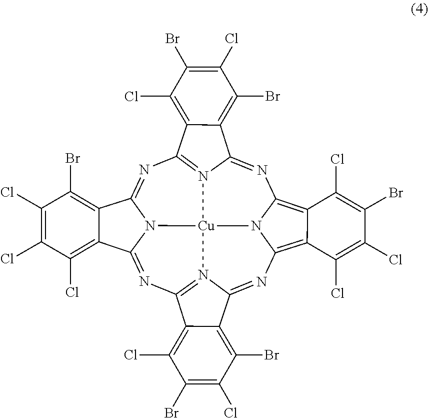

In the pigment (B) having a structure represented by the following Formula (5), the total number of chlorine atoms is 0, and the total number of bromine atoms is 16.

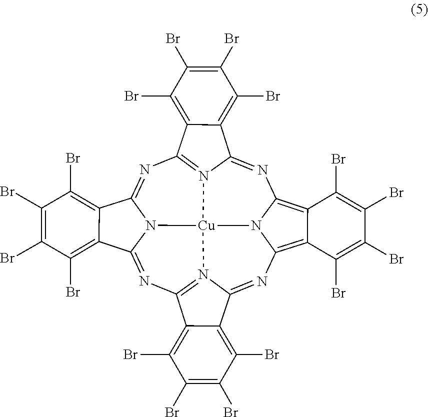

In the pigment (a) having a structure represented by the following Formula (6), the total number of chlorine atoms is 11, and the total number of bromine atoms is 5.

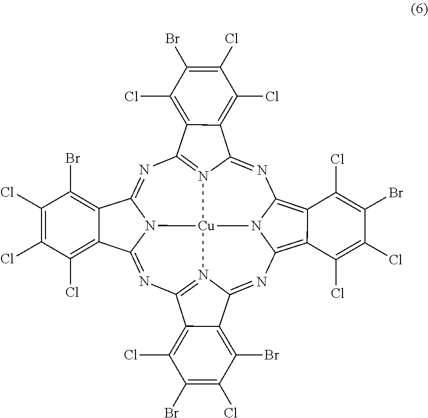

In the pigment (b) having a structure represented by the following Formula (7), the total number of chlorine atoms is 16, and the total number of bromine atoms is 0.

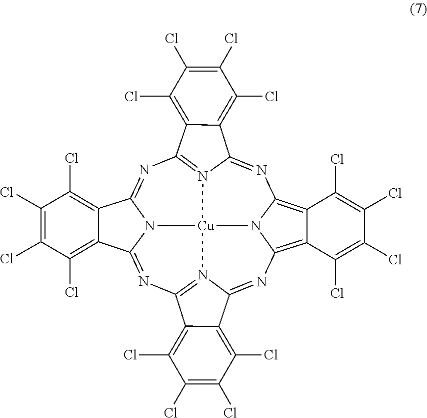

### 2. Preparation of Non-Aqueous Ink Jet Ink Composition Examples 1 to 28 and Comparative Examples 1 to 6

Each component was put into a mixture tank so as to have the composition described in Table 1, the mixture was mixed and stirred for 2 hours with a magnetic stirrer, and then the mixture was filtered through a membrane filter having a pore size of 5 μm to obtain a non-aqueous ink jet ink composition according to each of the Examples and Comparative Examples. The numerical values in Table 2 indicate percentage (%) by mass. As water, ion-exchanged water was used and added such that the mass of each ink was 100% by mass. The numerical values in each example in Table 1 indicate percentage (%) by mass. The percentage (%) by mass of the resin is shown as a solid content.

Furthermore, each component shown in Table 1 is as follows.

### Pigment

Pigments (A), (B), (a), and (b) . . . the above-described pigments (A), (B), (a), and (b)

### Organic Solvent

### Glycol Diether Represented by Formula (2)

Diethylene glycol ethyl methyl ether
Diethylene glycol diethyl ether
   Tetraethylene glycol dimethyl ether Glycol diether
   Octaethylene glycol dimethyl ether

### Glycol Diether Represented by Formula (3)

Triethylene glycol monobutyl ether
Tetraethylene glycol monobutyl ether
Dipropylene glycol monomethyl ether
Ethylene glycol monobutyl ether
Octaethylene glycol monomethyl ether

### Cyclic Lactone

γ-Butyrolactone
ε-Caprolactone

### Resin

SOLBIN CL . . . SOLBIN (registered trademark) CL (trade name, manufactured by Nissin Chemical Industry Co., Ltd., a copolymer resin of vinyl chloride and vinyl acetate)
PARALOID B60 . . . PARALOID (registered trademark) B-60 (trade name, manufactured by Dow Chemical Company, acrylic resin)

### Dispersant

SOLSPERSE 37500 . . . SOLSPERSE (registered trademark) 47000 (trade name, manufactured by Lubrizol Corporation, urethane resin)

### Surfactant

BYK-340 . . . BYK (registered trademark) 340 (trade name, manufactured by BYK Chemie Japan K.K., silicone-based surfactant)

### 3. Evaluation Methods

### 3.1. Chroma

Each of the non-aqueous ink jet ink compositions obtained in the Examples and the Comparative Examples was charged into the discharge head of an ink jet printer SC-S70650 (trade name, manufactured by Seiko Epson Corporation). Next, a vinyl chloride medium IJ180-10 (model number, manufactured by 3M Company) serving a recording medium was loaded into the printer, and a solid pattern with a density of 100% was produced under the conditions of a coating amount of 10 mg/inch² and a resolution of 720×1440 dpi, and each recorded matter was obtained. The temperature of the platen in the above-described printer was maintained at 45° C. for 1 minute during the production of the recorded matter and after the production of the recorded matter. Furthermore, even when there were areas where the discharge is insufficient due to discharge failure, any operation of compensating for the defective areas was not performed.

The chroma (C*) of each obtained recorded matter was evaluated. Specifically, for each obtained recorded matter, the color was measured to obtain the a* value and the b* value using a colorimeter i1BasicPro3 (trade name, manufactured by X-Rite, Inc.), C* was calculated, and the chroma was evaluated according to the following evaluation criteria. The value of C* was an integer value obtained by rounding off the calculated value of C* to the nearest whole number. Those results are shown in Table 2.

### Criteria

1: The C* value is less than 85.
2: The C* value is 85 or more and less than 90.
3: The C* value is 90 or more and less than 95.
4: The C* value is 95 or more and less than 100.
5: The C* value is 100 or more.

### 3.2. Bronze Characteristics

Each of the recorded matters obtained in the same manner as in the above-described section “3.1. Chroma” was checked by visual inspection. Subsequently, each of the recorded matters was observed by using a digital microscope VHX-6000 (trade name, manufactured by Keyence Corporation) under epi-illumination. Based on the observation results, the bronze characteristics were evaluated according to the following evaluation criteria. Those results are shown in Table 2.

### Criteria

1: It could be verified by visual inspection and under a microscope that the recorded matter had remarkable bronze characteristics, and it could be further verified under a microscope that the recorded matter had a reddish color.
2: It could be verified by visual inspection and under a microscope that the recorded matter had slight bronze characteristics, and it could be further verified under a microscope that the recorded matter had a reddish color.
3: It could not be verified by visual inspection and under a microscope that the recorded matter had bronze characteristics; however, it could be verified under a microscope that the recorded matter had a reddish color.
4: It could not be verified by visual inspection and under a microscope that the recorded matter had bronze characteristics, it could not be verified even under a microscope that the recorded matter had a reddish color, and it could be verified that the printed matter had a green color.

### 3.3. Scratch Resistance

For Each of the Recorded Matters Obtained in the same manner as in the above-described section “3.1. Chroma”, the scratch resistance was evaluated using a Gakushin type rubbing fastness tester AB-301 (product name, manufactured by Tester Sangyo Co., Ltd.) in accordance with JIS K5701:2000. Specifically, a cotton cloth was placed on the recording surface of the recorded matter, the recording surface was rubbed 20 times with a load of 500 g, peeling of the recording surface and ink transfer to the cotton cloth after the rubbing were visually checked, and the scratch resistance was evaluated according to the following evaluation criteria. Those results are shown in Table 2.

### Criteria

1: Notable peeling of the recording surface and ink transfer to the cotton cloth were recognized.
2: Peeling of the recording surface and ink transfer to the cotton cloth were recognized.
3: Peeling of the recording surface was not observed, but ink transfer to the cotton cloth was slightly recognized.
4: Both peeling of the recording surface and ink transfer to the cotton cloth were not recognized.

As shown in Table 2, it was found that the ink composition of the present embodiment can provide an ink composition that exhibits a green color with favorable image quality such as bronze characteristics and chroma, and has favorable scratch resistance and discharge stability.

Furthermore, from a comparison of Examples 1, 4, and 5 with Examples 2 and 3, it was found that when a pigment in which the number of bromine atoms for X in Formula (1) is more than 6 is used, an ink composition that has favorable scratch resistance and discharge stability and also exhibits a green color with more favorable image quality such as bronze characteristics and chroma, can be obtained.

From a comparison of Examples 4 and 5 with Comparative Example 1, it was found that when a pigment in which the number of bromine atoms for X in Formula (1) is 6 or more is used, even when the ink composition contains a pigment in which the number of bromine atoms for X in Formula (1) is less than 6, an ink composition that exhibits a green color with favorable image quality such as bronze characteristics and chroma and has favorable scratch resistance and discharge stability, can be obtained.

From a comparison of Examples 1, 7, and 8 with Examples 6 and 9, it was found that when the content of a pigment in which the number of bromine atoms for X in Formula (1) is 6 or more is 1.5 parts by mass or more and 4.5 parts by mass or less with respect to the total amount of the ink composition, an ink composition that exhibits a green color with more favorable image quality such as bronze characteristics and chroma and has more favorable scratch resistance and discharge stability, can be obtained.

From a comparison of Examples 1 and 10 with Example 11, it was found that when an ink composition containing one or more selected from the group consisting of diethylene glycol ethyl methyl ether and diethylene glycol diethyl ether as the glycol diether is used, an ink composition that exhibits a green color with more favorable image quality such as bronze characteristics and chroma and has more favorable scratch resistance and discharge stability, can be obtained.

From a comparison between Example 1 and Example 12, it was found that when γ-butyrolactone is used as the cyclic lactone, an ink composition that has favorable scratch resistance and discharge stability and also exhibits a green color with more favorable image quality such as bronze characteristics and chroma, can be obtained.

From a comparison of Examples 1, 13, and 15 with Examples 14 and 20, it was found that when an ink composition containing one or more selected from the group consisting of triethylene glycol monobutyl ether, tetraethylene glycol monobutyl ether, and ethylene glycol monobutyl ether as the glycol monoether, an ink composition that exhibits a green color with more favorable image quality such as bronze characteristics and chroma and has more favorable scratch resistance and discharge stability, can be obtained.

From a comparison of Example 1 with Examples 16 to 19, it was found that when an ink composition in which the content of the glycol diether is 45.0 parts by mass or more and 75.0 parts by mass or less with respect to 100 parts by mass of the total amount of the ink composition, the content of the glycol monoether is 7.0 parts by mass or more and 20.0 parts by mass or less with respect to 100 parts by mass of the total amount of the ink composition, and the content of the cyclic lactone is 7.0 parts by mass or more and 15.0 parts by mass or less with respect to 100 parts by mass of the total amount of the ink composition, an ink composition that exhibits a green color with more favorable image quality such as bronze characteristics and chroma and has more favorable scratch resistance and discharge stability, can be obtained.

What is claimed is:

1. A non-aqueous ink jet ink composition comprising:
a pigment represented by the following Formula (1); and
an organic solvent, wherein
the organic solvent includes a glycol diether represented by the following Formula (2), 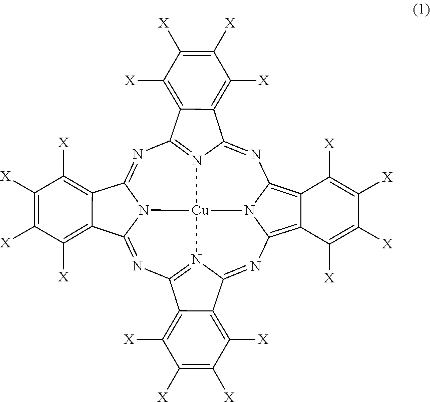
in Formula (1), X's each independently represent a chlorine atom or a bromine atom, and a total number of bromine atoms for X is 6 or more, 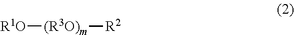
in Formula (2), R¹ and R² each independently represent an alkyl group having 1 or more and 7 or fewer carbon atoms, R³ represents an alkylene group having 1 or more and 3 or fewer carbon atoms, and m represents an integer of 1 or more and 7 or less.

2. The non-aqueous ink jet ink composition according to claim 1, wherein
the organic solvent further includes a glycol monoether represented by the following Formula (3): 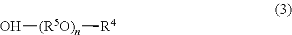
in Formula (3), R⁴ represents an alkyl group having 1 or more and 7 or fewer carbon atoms, R⁵ represents an alkylene group having 1 or more and 3 or fewer carbon atoms, and n represents an integer of 1 or more and 8 or less.

3. The non-aqueous ink jet ink composition according to claim 1, wherein
the organic solvent further includes a cyclic lactone.

4. The non-aqueous ink jet ink composition according to claim 1, wherein
a content of the pigment is 0.5 parts by mass or more and 10.0 parts by mass or less with respect to 100 parts by mass of a total amount of the non-aqueous ink jet ink composition.

5. The non-aqueous ink jet ink composition according to claim 1, wherein
a content of the glycol diether is 5.0 parts by mass or more and 90.0 parts by mass or less with respect to 100 parts by mass of a total amount of the non-aqueous ink jet ink composition.

6. The non-aqueous ink jet ink composition according to claim 2, wherein
a content of the glycol monoether is 5.0 parts by mass or more and 80.0 parts by mass or less with respect to 100 parts by mass of a total amount of the non-aqueous ink jet ink composition.

7. The non-aqueous ink jet ink composition according to claim 3, wherein
a content of the cyclic lactone is 1.0 part by mass or more and 50.0 parts by mass or less with respect to 100 parts by mass of a total amount of the non-aqueous ink jet ink composition.

8. The non-aqueous ink jet ink composition according to claim 1, wherein
the glycol diether includes one or more selected from the group consisting of diethylene glycol ethyl methyl ether, diethylene glycol diethyl ether, and tetraethylene glycol dimethyl ether.

9. The non-aqueous ink jet ink composition according to claim 2, wherein
the glycol monoether includes one or more selected from the group consisting of triethylene glycol monobutyl ether, tetraethylene glycol monobutyl ether, dipropylene glycol monomethyl ether, ethylene glycol monobutyl ether, and octaethylene glycol monomethyl ether.

10. An ink jet recording method, comprising:
discharging the non-aqueous ink jet ink composition according to claim 1 from an ink jet head by using an ink jet method to cause the non-aqueous ink jet ink composition to adhere to a recording medium.

11. The ink jet recording method according to claim 10, wherein
the recording medium contains a vinyl chloride-based resin.
